(19) United States
(12) Patent Application Publication
(10) Pub. No.: US 2010/0051145 A1
(43) Pub. Date: Mar. 4, 2010

(54) EGR COOLER FOR VEHICLES AND METHOD OF MANUFACTURING THE SAME

(75) Inventor: Jae Gyu Jung, Gyeonggi-do (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/466,418

(22) Filed: May 15, 2009

(30) Foreign Application Priority Data
Aug. 26, 2008 (KR) 10-2008-0083263

(51) Int. Cl. C21D 6/02; C22C 38/18

(52) U.S. Cl. 148/607; 148/326

(57) ABSTRACT

Disclosed herein is an EGR cooler for a vehicle, which is made of ferrite stainless steel, the ferrite stainless steel including: 0.025˜0.03 wt % of carbon (C), 0.2˜0.8 wt % of silicon (Si), 0.05˜0.8 wt % of manganese (Mn), 0.01˜0.04 wt % of phosphorus (P), 0.01˜0.03 wt % of sulfur (S), 19˜22 wt % of chromium (Cr), 0.2˜0.6 wt % of copper (Cu), 0.25˜0.8 wt % of niobium (Nb) or titanium (Ti), and the balance of iron. A method of manufacturing the EGR cooler for a vehicle includes: heating ferrite stainless steel to a temperature of 1000˜1100° C., maintaining the heated ferrite stainless steel for 30˜60 minutes and then cooling the resulting heated ferrite stainless steel with water; and acid-treating the ferrite stainless steel using an acid solution in which nitric acid and fluoric acid are mixed with distilled water.

### CROSS-REFERENCE TO RELATED APPLICATIONS

This application claims under 35 U.S.C. §119(a) priority to Korean Application No. 10-2008-0083263, filed on Aug. 26, 2008, the disclosure of which is incorporated herein by reference in its entirety.

### BACKGROUND

1. Technical Field

The present disclosure relates to an exhaust gas recirculation (EGR) cooler for vehicles, made of ferrite stainless steel, and a method of manufacturing the same.

2. Description of the Related Art

An EGR system for controlling the discharge of nitrogen oxides is used to increase the thermal capacity of a fuel mixture by recirculating a part of exhaust gas discharged from a vehicle to an intake system and to reduce the amount of nitrogen oxides discharged from a vehicle by decreasing the amount of oxygen introduced into a combustion chamber. The EGR system is provided with an EGR cooler for preventing the rapid rise in temperature of exhaust gas by heat exchange between the cooling water and the exhaust gas.

In particular, a conventional EGR cooler is made of austenite stainless steel having an austenite structure of Fe—Cr—Ni, wherein the austenite stainless steel contains nickel (Ni) functioning to stabilize the austenite structure at room temperature. However, since the nickel (Ni) which is used to manufacture the EGR cooler is an expensive element, there is a problem in that production costs are increased depending on the rise in the prices of raw materials.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made keeping in mind the above problems occurring in the prior art, and an object of the present invention is to provide an EGR cooler for vehicles, made of ferrite stainless steel, which can realize precise castability and excellent corrosion resistance.

In order to accomplish the above object, an aspect of the present invention provides a method of manufacturing an EGR cooler for a vehicle, in which the EGR cooler is manufactured by heat-treating and acid-treating ferrite stainless steel. In particular, ferrite stainless steel is heated to a temperature of 1000˜1100° C. and maintained for 30˜60 minutes and then cooled with water. The thus-obtained ferrite stainless steel is acid-treated using an acid solution including nitric acid and fluoric acid.

Another aspect of the present invention provides an EGR cooler for a vehicle, which is made of ferrite stainless steel comprising: 0.025˜0.03 wt % of carbon (C), 0.2˜0.8 wt % of silicon (Si), 0.05˜0.8 wt % of manganese (Mn), 0.01˜0.04 wt % of phosphorus (P), 0.01˜0.03 wt % of sulfur (S), 19˜22 wt % of chromium (Cr), 0.2˜0.6 wt % of copper (Cu), 0.25˜0.8 wt % of niobium (Nb) or titanium (Ti), and the balance of iron.

The above and other objects, aspects and features will be described infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing a heat treatment process in a method of manufacturing an EGR cooler according to an embodiment of the present invention;

FIGS. 2A and 2B are photographs showing the surface of a heat- and acid-treated EGR cooler according to an embodiment of the present invention which is obtained after a predetermined time after salt water is sprayed on the surface;

FIGS. 3A to 3D are photographs showing outer appearances of a heat and acid-treated EGR cooler according to an embodiment of the present invention;

FIGS. 4A to 4D are photographs showing outer appearances of a heat-treated and acid-treated EGR cooler according to an embodiment of the present invention which is obtained after 1000 hours passed after salt water containing 5% sodium hydroxide (NaCl) is sprayed on the surface thereof;

FIG. 5 is a graph showing potentials measured in a state in which an EGR cooler is heat- and acid-treated at 30-minute intervals.

### DETAILED DESCRIPTION OF EMBODIMENTS

An EGR cooler according to an embodiment of the present invention is realized using ferrite stainless steel including carbon (C), silicon (Si), manganese (Mn), phosphorus (P), sulfur (S), chromium (Cr), copper (Cu), niobium (Nb) or titanium (Ti), and the balance of iron (Fe), and in that this ferrite stainless steel is heat- and acid-treated at a predetermined temperature for a predetermined time, thereby manufacturing an EGR cooler having precise castability and excellent corrosion resistance.

Specifically, the EGR cooler according to the present invention is manufactured using ferrite stainless steel including 0.025˜0.03 wt % of carbon (C), 0.2˜0.8 wt % of silicon (Si), 0.05˜0.8 wt % of manganese (Mn), 0.01˜0.04 wt % of phosphorus (P), 0.01˜0.03 wt % of sulfur (S), 19˜22 wt % of chromium (Cr), 0.2˜0.6 wt % of copper (Cu), 0.25˜0.8 wt % of niobium (Nb) or titanium (Ti), and the balance of iron.

In the EGR cooler made of the ferrite stainless steel, carbon (C) serves to increase the strength of the ferrite stainless steel, silicon (Si) is realized as a ferrite stabilization element, manganese (Mn) serves as a deoxidizing agent or a desulfurizing agent during the casting process, and phosphorus (P) and sulfur (S) have characteristics of elements having a low melting point. That is, the respective components have independent characteristics.

Accordingly, in order to manufacture an EGR cooler having excellent castability at the same time as making use of the characteristics of the components of the ferrite stainless steel, it is required to combine these components with each other in proper ratios. After numerous trials and errors, the present inventors have found that the above-described ratios are optimal.

Hereinafter, without intending to limit a theory, the reason for the numerical limitation of the composition of the EGR cooler according to the present invention will be described as follows.

(i) 0.025˜0.03 wt % of Carbon (C)

Carbon (C) is an austenite stabilization element, and is a main component serving to increase the strength of steel. Generally, carbide such as Cr₂₃C₆ is precipitated in the grain boundary of a material at a high temperature to reduce the performance of the material requiring corrosion resistance. The reason why the carbide is precipitated in the grain boundary of the material is that since grain boundary energy is relatively higher than transgranular energy, the material is stabilized due to the precipitation of carbide. This precipitated carbide (Cr₂₃C₆) serves to locally decrease the amount of chromium (Cr) present in the material as a solid solution, so that a chromium (Cr) zone, in which chromium content is relatively lower than that in matrix, is formed, thereby decreasing corrosion resistance. Therefore, in the EGR cooler of the present invention, in order to prevent the formation of chromium carbide at high temperature, it is required to control the amount of carbon in the range of 0.025˜0.03 wt %.

(ii) 0.2˜0.8 wt % of Silicon (Si)

Silicon (Si) is a ferrite stabilization element, and acts as a deoxidizing agent. When the additive amount of silicon (Si) present in a material as a solid solution is increased, it is an effective element used to improve high-temperature oxidation and corrosion characteristics. In particular, silicon (Si) serves to improve corrosion resistance to water of high sulfuric acid concentration produced in an exhaust gas cooling system such as an EGR cooler. However, when the amount of silicon is excessive, oxides are formed in large amounts during or after casting, so that it is difficult to remove molds and ceramic coatings, with the result that it is preferred that the amount of silicon be 0.8 wt % or less. In contrast, when the amount of silicon is less than 0.2 wt %, it is difficult to improve high-temperature oxidation and corrosion characteristics.

(iii) 0.05˜0.8 wt % wt % of Manganese (Mn)

Manganese (Mn) serves as a deoxidizing agent or a desulfurizing agent in a casting process, and is formed into MnO or MnS. In particular, manganese (Mn) serves to prevent steel from cracking at high temperatures by early inhibition of the formation of iron (Fe) compounds and sulfur (S) compounds. Further, manganese (Mn) is one of the five elements constituting steel, and serves to improve the high-temperature strength of steel by increasing the bonding force between atoms, and thus it can contribute to the improvement in strength of parts of the EGR cooler. Moreover, since manganese (Mn) has a molecular weight of about 55, which is similar to that of iron (Fe) of 56, it maintains the bonding force between atoms even at a high temperature. When a large amount of manganese (Mn) is added for the purpose of the stabilization of texture, manganese (Mn) may act as a harmful element. For this reason, it preferred that the amount of manganese (Mn) be 0.8 wt % or less. However, when the amount of manganese (Mn) is less than 0.05 wt %, manganese (Mn) cannot suitably serve as a desulfurizing agent.

(iv) 0.01˜0.04 wt % of Phosphorus (P) and 0.01˜0.03 wt % of Sulfur(S)

Phosphorus (P) and sulfur (S) are typical elements having a low melting point, and are elements which are most slowly solidified in the cooling zone after casting. In the solidification of a cast microstructure, the cast microstructure is solidified from surface to core, and, in this case, the two elements remain on the grain boundary in the material. Adjacent textures solidified in the material are constricted during the solidification process. In this case, since elements having a low melting point cannot be solidified, they are influenced by tensile stress, thereby causing cast defects and cracks. For this reason, it is preferred that the amounts of phosphorus (P) and sulfur (S) be 0.04 wt or less and 0.03 wt % or less, respectively. When the amounts of both phosphorus (P) and sulfur (S) are less than 0.01 wt % their functioning becomes weak, so that it is preferred that the amounts of phosphorus (P) and sulfur (S) be 0.01 wt % or more, respectively.

(v) 19˜22 wt % of Chromium (Cr)

Chromium (Cr) is a ferrite stainless steel stabilization element having a body centered cubic (BCC) crystal structure. Stainless steel normally includes at least 11.5 wt % of chromium (Cr). The reason why stainless steel has excellent corrosion resistance is that a chromium oxide (Cr₂O₃) layer, called a passive layer, is formed on the surface of the stainless steel to a thin thickness of about 1˜2 nm. The homogenization and compactness of the passive layer is correlated with the amount of chromium (Cr). With an increase in the amount of chromium, the corrosion resistance of stainless steel is improved. In case of manufacturing a cast steel having a cast microstructure, the surface of the cast steel is greatly corroded by salt water containing chlorine ions (Cl⁻) after casting, which necessitates a post-process. The post-process includes an acid treatment process in addition to a heat treatment process. In the post-process, the heat treatment process is conducted at a temperature of about 1050° C., and the time taken to conduct the acid treatment process may be determined depending on the amount of oxidized scales formed through the heat treatment process. Further, an acid treatment solution and an acid treatment temperature may be changed depending on the quality of the materials. Moreover, since the parts of the EGR cooler of the present invention must have resistance to salt water, the parts made of the cast steel including about 11.5 wt % of chromium (Cr) cannot maintain constant durability. Therefore, the amount of chromium (Cr) is controlled in the range of 19˜22 wt %. In this range, a salt water spray test for 1000 hours shows no problem associated with the corrosion of the stainless steel. However, when the amount of chromium (Cr) is less than 19 wt %, there are problems in that since a large amount of oxidized scales are formed during heat treatment, the time taken to conduct an acid treatment process for removing the oxidized scales, which is a post process, must be increased, and the concentration of an acid treatment solution must also be increased, and in that since the amount of chromium included in the stainless steel is low, the surface of the stainless steel is corroded by an acid used in the acid treatment. Meanwhile, in a precise casting process, a mold is coated with ceramics, and then the ceramic coating is removed from the mold after the preparation of molten metal and the cooling thereof. On the other hand, when the amount of chromium (Cr) is more than 22 wt %, there is a problem in that since a coating layer is not easily removed, it is difficult to stabilize a passive layer.

(vi) 0.2˜0.6 wt % of Copper (Cu)

Generally, copper (Cu) is an element which can improve cold formability, and is advantageous in the manufacturing of stainless plates. In the manufacturing of cast steel, copper (Cu) serves to improve the corrosion resistance of the cast steel, and, particularly, since the cast steel including copper has high corrosion resistance to sulfuric acid, the cast steel may be greatly advantageous in the manufacturing of parts of an EGR cooler. The parts of the EGR cooler serve to cool exhaust gas and then recirculate the cooled exhaust gas to the combustion chamber of an engine. That is, at the time of cooling the exhaust gas, as the high temperature exhaust gas is changed into a liquid phase, condensed water (cooling water) is mixed with SOₓ included in the exhaust gas to form a sulfuric acid solution, and thus the condensed water including the sulfuric acid serves to accelerate the corrosion of the material. Therefore, when the amount of copper (Cu) is excessively increased, a mold may be contaminated, and thus the quality of a product may be deteriorated. Accordingly, it is preferred that the amount of copper (Cu) be 0.3˜0.6 wt %.

(vii) 0.25˜0.8 wt % of Niobium (Nb) or Titanium (Ti)

Niobium (Nb) or titanium (Ti) is a crystal grain miniaturization element. Since Niobium (Nb) or titanium (Ti) has high affinity for carbon, the carbide thereof is first formed at a high temperature, and thus Niobium (Nb) or titanium (Ti) serves to prevent the sensitization of a grain boundary attributable to the formation of chromium carbide. The main carbide of Niobium (Nb) or titanium (Ti) is NbC or TiC, and NbC or TiC also serves to improve the resistance to thermal fatigue. Further, it is known that Niobium (Nb) or titanium (Ti) is an element which can increase high temperature strength as the amount thereof is increased and which can easily control inclusions. However, when an excessive amount of Niobium (Nb) or titanium (Ti) is added, since hot cracks are formed immediately after solidification and impact resistance is deteriorated, Niobium (Nb) or titanium (Ti) is limitedly used in the present invention. Niobium (Nb) or titanium (Ti) is independently or concomitantly added such that the amount thereof is 0.25˜0.8 wt %. When the amount thereof is more than 0.8 wt %, hot cracks may be easily formed. In contrast, when the amount thereof is less than 0.25 wt %, the functioning thereof may become weak.

(viii) Balance of Iron (Fe)

Iron (Fe) is the balance of the components constituting the above ferrite stainless steel. When the amount of iron (Fe) deviates from a predetermined range, there is a problem in that, since the ratio of other components is decreased, it is difficult to realize the function of ferrite stainless steel through the characteristics of other components.

As described above, an EGR cooler made of ferrite stainless steel including carbon (C), silicon (Si), manganese (Mn), phosphorus (P), sulfur (S), chromium (Cr), copper (Cu), niobium (Nb) or titanium (Ti), and a balance of iron (Fe) is manufactured through a heat treatment process and an acid treatment process.

Hereinafter, embodiments of the present invention will be described in more detail with reference to the attached drawings.

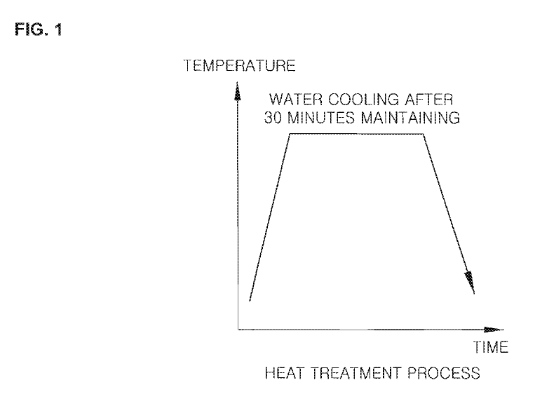

FIG. 1 is a graph showing a heat treatment process in a method of manufacturing an EGR cooler according to an embodiment of the present invention.

Referring to FIG. 1, the aforementioned ferrite stainless steel is heat-treated and then acid-treated to form an EGR cooler. In this case, the heat treatment of the ferrite stainless steel is conducted by heating the ferrite stainless steel to a temperature of 1000˜1100° C., maintaining the heated ferrite stainless steel for 30˜60 minutes and then cooling the resulting heated ferrite stainless steel with water, and the acid treatment of the heat-treated ferrite stainless steel is conducted using an acid solution in which nitric acid and fluoric acid are mixed with distilled water.

The acid treatment process is necessarily conducted after the heat treatment process. In this acid treatment process, commercially available nitric acid having a concentration of 60% and fluoric acid having a concentration of 48˜51% may be used.

Generally, 15˜20% of nitric acid and 80% of distilled water are used in a process of manufacturing ferrite stainless plate. In case of a ferrite stainless cast steel, in order to remove oxidized scales formed after the heat treatment and to form a homogeneous passive layer, the acid treatment can be conducted using an acid solution including nitric acid (30%), fluoric acid (10%) and distilled water (60%) even at room temperature. Alternatively, the acid treatment can be conducted by using the acid solution including nitric acid (30%), fluoric acid (10%) and distilled water (60%) heated to a temperature of 50˜70° C.

In the acid solution, nitric acid is advantageous in that it can entirely remove oxidized scales from the surface of ferrite stainless steel, and in that, since it has excellent penetrability and destructibility, the oxidized scales can be removed in a depth direction. A preferable concentration of nitric acid is 30%.

In the acid solution, when the concentration of fluoric acid is low, oxidized scales formed near the edges of the ferrite stainless steel cannot be completely removed in the case where the oxidized scales are removed in a depth direction under an optimal heat treatment time condition (30˜60 minutes). In contrast, when the concentration of fluoric acid is high, the concentration of nitric acid is relatively decreased, so that a surface reaction becomes slow, with the result that the surface of ferrite stainless steel may be pitted.

Hereinafter, Experimental Examples for evaluating the excellent characteristics of an EGR cooler manufactured by heat-treating and then acid-treating ferrite stainless steel according the present invention will be described as follows.

### Experimental Example 1

The composition of the ferrite stainless steel constituting an EGR cooler according to an embodiment of the present invention (Example) and that of a conventional EGR cooler (Comparative Example) are shown in Table 1 below.

TABLE 1

| Class | C | Si | Mn | P | S | Cr | Nb | Ti | Cu | Remark |
|---|---|---|---|---|---|---|---|---|---|---|
| Exp. | 0.028 | 0.6 | 0.04 | 0.02 | 0.02 | 18.00 | 0.2 | | 0.4 | |
| Com. | 0.025 | 1.00 | 1.00 | 0.04 | 0.03 | 18.00 | — | 0.50 | — | SUS439L |

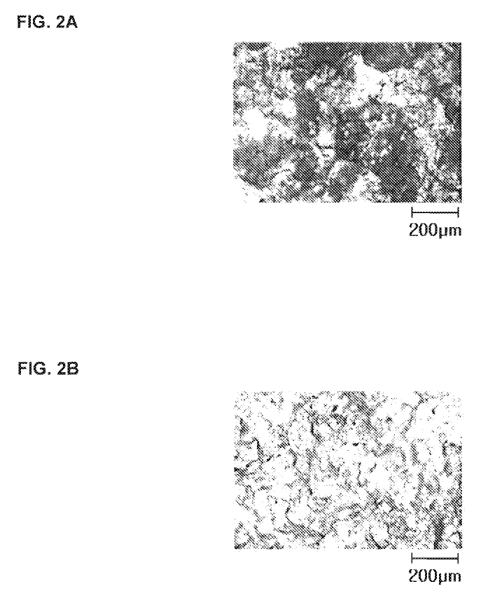

FIGS. 2A and 2B are photographs showing the surfaces of a heat- and acid-treated EGR coolers according to Comparative Example and Example of the present invention which are obtained after a predetermined time after salt water is sprayed on the respective surfaces.

In the case of the EGR cooler of the Comparative Example, the surface thereof was corroded by salt water after 24 hours (see FIG. 2A). In the case of the EGR cooler of the Example, however, the surface thereof was not corroded by salt water even after 1000 hours (see FIG. 2B).

### Experimental Example 2

EGR coolers were fabricated by the above-described method according to the present invention, in which ferrite stainless steel was heat-treated and then acid-treated at 30-minute intervals as given in Table 2. In this case, the heat treatment was conducted at 1050° C.

TABLE 2

Heat treatment
time (min)

| Class. | 30 | 60 | 90 | 120 |
|---|---|---|---|---|
| Acid treatment | 8 | 10 | 15 | 20 |

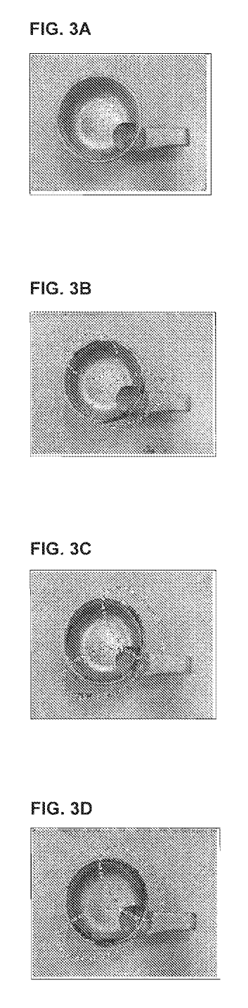

FIGS. 3A to 3D are photographs showing the outer appearances of the thus-prepared EGR coolers.

When the heat treatment was conducted for 30 minutes, the outer appearance of the EGR cooler did not change (see FIG. 3A), when the heat treatment was conducted for 60 minutes, a small amount of oxidized scales was formed on the edge of the EGR cooler (see FIG. 3B), when the heat treatment was conducted for 90 minutes, oxidized scales were formed in greater number than when the heat treatment was conducted for 60 minutes (see FIG. 3C), and when the heat treatment was conducted for 120 minutes, oxidized scales were formed in a greater number than when the heat treatment was conducted for 90 minutes (see FIG. 3D). Accordingly, a preferable time for the heat treatment was 30 to 60 minutes.

### Experimental Example 3

Salt water containing 5% sodium hydroxide (NaCl) was sprayed on the EGR coolers fabricated in Experimental Example 2.

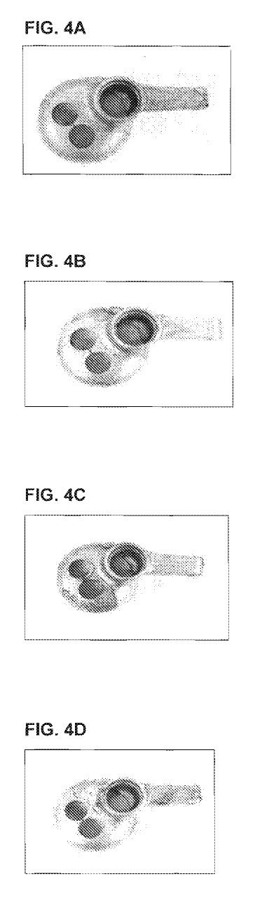

FIGS. 4A to 4D are photographs showing the outer appearances of the—thus heat-treated and acid-treated EGR coolers after 1000 hours passed after salt water containing 5% sodium hydroxide (NaCl) was sprayed on the surfaces thereof.

Referring to FIGS. 4A to 4D, the surfaces of the EGR coolers were slightly corroded. The slight corrosion of the surfaces of the EGR coolers was caused by the slight corrosion phenomenon of the cut surface thereof, not by the self-corrosion of the material of the EGR cooler. Therefore, it was determined that the outer appearance of the EGR cooler was entirely satisfactory. Moreover, considering that an EGR cooler is located in an engine room, it would be difficult for chlorine ions (Cl⁻) present in salt water to corrode the EGR cooler.

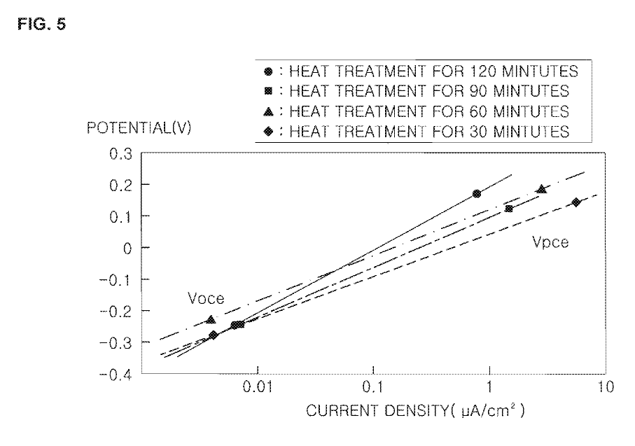

Meanwhile, FIG. 5 is a graph showing potentials measured for the EGR coolers heat- and acid-treated at 30-minute intervals. Here, V_{oce} is the open circuit electric potential, and V_{pce} is the pitting corrosion electric potential.

As shown in FIG. 5, there was a correlation between the starting point of passivation or pitting and the heat treatment. That is, the resistance of the EGR cooler to salt water in the case where the heat treatment time was 120 minutes was about seven times that in the case where the heat treatment time was 30 minutes.

As described above, EGR coolers according to embodiments of the present invention have precise castability and excellent corrosion resistance and can be manufactured in a cost-effective way.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing an EGR cooler for a vehicle, comprising:
heating ferrite stainless steel to a temperature of 1000˜1100° C., maintaining the heated ferrite stainless steel for 30˜60 minutes and then cooling the resulting heated ferrite stainless steel with water; and
acid-treating the ferrite stainless steel using an acid solution in which nitric acid and fluoric acid are mixed with distilled water.

2. The method of manufacturing an EGR cooler according to claim 1, wherein the acid-treatment of the ferrite stainless steel is conducted using the acid solution heated to a temperature of 50˜70° C. or at room temperature.

3. The method of manufacturing an EGR cooler according to claim 1, wherein the ferrite stainless steel comprises 0.025˜0.03 wt % of carbon (C), 0.2˜0.8 wt of silicon (Si), 0.05˜0.8 wt % of manganese (Mn), 0.01˜0.04 wt % of phosphorus (P), 0.01˜0.03 wt % of sulfur (S), 19˜22 wt % of chromium (Cr), 0.2˜0.6 wt % of copper (Cu), 0.25˜0.8 wt % of niobium (Nb) or titanium (Ti), and the balance of iron.

4. An EGR cooler for a vehicle made of ferrite stainless steel comprising: 0.025˜0.03 wt % of carbon (C), 0.2˜0.8 wt % of silicon (Si), 0.05˜0.8 wt % of manganese (Mn), 0.01˜0.04 wt % of phosphorus (P), 0.01˜0.03 wt % of sulfur (S), 19˜22 wt % of chromium (Cr), 0.2˜0.6 wt % of copper (Cu), 0.25˜0.8 wt % of niobium (Nb) or titanium (Ti), and the balance of iron.

5. The EGR cooler for a vehicle according to claim 4 manufactured by a method comprising:
heating ferrite stainless steel to a temperature of 1000˜1100° C., maintaining the heated ferrite stainless steel for 30˜60 minutes and then cooling the resulting heated ferrite stainless steel with water; and
acid-treating the ferrite stainless steel using an acid solution in which nitric acid and fluoric acid are mixed with distilled water.

6. The EGR cooler for a vehicle according to claim 5, wherein the acid-treatment of the ferrite stainless steel is conducted using the acid solution heated to a temperature of 50˜70° C. or at room temperature.
